(19) United States
(12) Patent Application Publication
(10) Pub. No.: US 2024/0254320 A1
(43) Pub. Date: Aug. 1, 2024

(54) TIN-BASED STABILIZERS FOR POST-HALOGENATED POLYMERS

(71) Applicant: PMC Organometallix, Inc., Mount Laurel, NJ (US)

(72) Inventors: Kevin John ROSS, Rockwood (CA); Gene Kelly NORRIS, West Chester, OH (US); Robert J SMITH, Horsham, PA (US)

(73) Assignee: PMC Organometallix, Inc., Mount Laurel, NJ (US)

(21) Appl. No.: 18/426,963

(22) Filed: Jan. 30, 2024

Related U.S. Application Data
(60) Provisional application No. 63/482,144, filed on Jan. 30, 2023.

(51) Int. Cl. C08K 13/04; C07F 7/22; C08J 3/20; C08J 3/22; C08K 3/22; C08K 5/37; C08K 5/58; C08L 27/24

(52) U.S. Cl. CPC C08K 13/04; C07F 7/226; C08J 3/203; C08J 3/226; C08L 27/24; C08J 2327/24; C08J 2491/00; C08K 2003/2241; C08K 5/37; C08K 5/58; C08K 2201/014; C08L 2201/08; C08L 2205/06; C08L 2310/00

(57) ABSTRACT

The invention relates to stabilized chlorinated polyvinyl chloride (CPVC) polymer formulations, and the stabilizers used therein. The stabilization is achieved through the use of a sulfide containing organotin species in conjunction with co-stabilizers and organic extenders which provide increased thermal stability relative to traditional organotin stabilizers.

### CROSS-REFERENCE TO RELATED APPLICATIONS

This application claims the benefit of U.S. Provisional Patent Application, Ser. No. 63/482,144, filed on 30 Jan. 2023. Priority of U.S. Provisional Patent Application, Ser. No. 63/482,144, filed on 30 Jan. 2023 is hereby claimed.

### BACKGROUND OF THE INVENTION

### 1. Field of the Invention

The present invention relates to a stabilizer composition for a post-halogenated, halogen-containing polymer. More particularly, the present invention relates to thermal stabilizers for halogen-containing polymers, which have been subject to post-halogenation, such as chlorinated poly vinyl chloride, (CPVC).

### 2. General Background of the Invention

Poly vinyl chloride (PVC) is a thermally unstable polymer at traditional processing temperatures and many stabilizer systems are available that attempt to address its inherent thermal instability. One method of improving the inherent instability of PVC is to subject the polymer to a process of post-halogenation, which produces chlorinated PVC, or CPVC. This resultant polymer has advantages over PVC and these advantages are familiar to those in the field, see for example U.S. Pat. Nos. 4,006,126; 4,039,732; and 4,350,798.

CPVC can be processed in manners similar to PVC and the stabilization technologies that were developed initially and primarily for PVC have been adopted for improving CPVC stability with success. Stabilizer systems based on dibutyltin bis(ethylhexylmercaptoacetate), also known as dibutyltin bis(EHMA), have dominated CPVC for many years but other tin-based systems such as those based on the dimethyl and di-octyl analogues of the dibutyl species have also found usage.

Thermal stabilizers for PVC have drawn extensive study for over 70 years and a variety of ligands, alkyl groups and extenders/co-stabilizers have been developed and optimized for specific applications. The use of sulfide as a ligand (known as “sulfiding”) in PVC thermal stabilizers has primarily found application in pipe and substrate applications as a co-ligand with reverse esters. While sulfiding allows the producer to obtain a lower cost PVC stabilizing system, performance relative to traditional ligands like EHMA typically suffers with respect to improving term stability. Typically, CPVC presents even greater challenges than PVC in order to process successfully and much effort has been expended to efficiently process CPVC. To that end, improvement in term stability of a given CPVC-based formulation is welcomed by processors.

In the field of PVC stabilization, there are multiple techniques to boost one or more aspects of stabilization performance which include, but are not limited to, the use of co-stabilizers, the use of excess free ligand (U.S. Pat. No. 6,919,392B1), variation in the ration of monoalkyl components to dialkyl components (mono/di ratio), and boosting tin content through “sulfiding” (PVC Handbook, Wilkes, 2005). More specifically, so-called “sulfiding” is a technique in which some quantity of the ligands in a control stabilizer are synthetically replaced with the addition of a source of sulfide, formally represented as S²⁻. This addition can be achieved in a number of ways known to those skilled in the art and the resultant new stabilizer contains a higher sulfur and tin content than the non-sulfided reference stabilizer. For the systems under discussion, the reference compound can be described as Bu₂Sn(EHMA)₂ and a range of sulfides represented as Bu₂Sn(EHMA)₂₋₂ₓ(S)ₓ, where x is typically in the range 0.1 to 0.45.

The use of a sulfide-based stabilizer, relative to its non-sulfide-based counterpart, in PVC typically can provide improvements in early and mid-term color but does not improve term stability. Sulfiding has found its primary application in reverse ester stabilizers for predominantly pipe applications where a sulfided stabilizer can provide economic advantages relative to a non-sulfided counterpart. It would be expected that a sulfide-based stabilizer would yield similar results with CPVC stabilization because PVC and CPVC typically react similarly to stabilization. However, contrary to this expectation, the stabilizer of the present invention achieves surprising improvement in term stability in CPVC-based formulations in isolation, and performance can be further enhanced when used in combination with a range of extenders.

The following PCT Application is incorporated herein by reference: International Publication No. WO200166638 for “HALOGEN CONTAINING POLYMER COMPOUNDS CONTAINING MODIFIED ZEOLITE STABILIZERS”.

### BRIEF SUMMARY OF THE INVENTION

The present invention includes compositions comprising known post-halogenated halogen-containing polymer stabilizers that have been improved through sulfiding and extending to boost performance without increasing tin content of the stabilizers. Known stabilizers include high dibutyltin bis(EHMA), and dimethyl and di-octyl analogues of these stabilizers. An example of a commercially available high dibutyltin bis(EHMA) stabilizer, Thermolite® 31, was used in experiment 1 detailed below. However, one with skill in the art would understand that other equivalent stabilizers could also be used and yield the same or similar results.

The present invention also includes methods of using the novel stabilizer to improve term stability of post-halogenated halogen-containing polymers. Experiments described below were done using a representative CPVC formulation detailed in Table 3. Ongoing experimentation is expected for other commercial CPVC compounds, and the same or similar results are expected. Additionally, it is expected that other post-halogenated halogen containing polymers would yield the same or similar results.

### DETAILED DESCRIPTION OF THE INVENTION

The present invention includes a novel stabilizer for use in post-halogenated halogen-containing polymer production. Examples and experiments have been done with CPVC, but it is expected that other post-halogenated polymers would behave the same or similarly.

The novel stabilizer of the present invention is created by sulfiding a traditional high di-EHMA stabilizer, and extending it with traditional organic extenders. The resulting stabilizer has shown improved term stability of post-halogenated, halogen-containing polymers. In some cases, over 50% improvement was shown.

The present invention also includes methods of improving term stability of CPVC using the novel stabilizers described herein.

The present invention also includes the resulting CPVC compounds containing the novel stabilizer described herein.

### Example 1

A typical stabilizer used in PVC is Thermolite® 31 and is available from PMC Organometallix, Inc. A sulfided version of this stabilizer, Stabilizer B (defined as Bu₂SnSₓ(EHMA)₂₋₂ₓ) was prepared and its utility explored in a PVC Formulation, Table 1. Its performance was compared to Thermolite® 31 and extensions (that is, combinations of Stabilizer B with organic liquids to lower tin content to that of the original stabilizer, Thermolite® 31). A common method for evaluation of thermal stability in PVC involves processing compound in a Brabender®, extracting samples at given times and taking color readings in a given color space. For samples under study here, CIE color space was used with particular focus on the b scale, see Table 2.

In the representative PVC formulation given in Table 1, Stabilizer B, provides poorer color control and shorter-term stability versus the un-sulfided control, Stabilizer A. Attempts to improve the performance of Stabilizer B via organic extensions, epoxidized soybean oil (ESBO) in Extension 1 and dodecylmercaptan (DDM) in Extension 2, were not successful. It was expected that similar outcomes would occur with CPVC.

In contrast to the findings in PVC, it was determined that Stabilizer B alone or in combination with extenders surprisingly improves the thermal stability performance within CPVC systems. Tables 4 and 5 summarize formulations tested and Tables 6 and 7 summarize results of Brabender testing for term stability.

A. Synthesis of high dibutyltin EHMA/Sulfide, Stabilizer B

151.8 grams (1 eq) of Dibutyl Tin Dichloride, 120.5 grams (0.59 eq), and 50 grams of water are added to the reactor and agitated. To this mixture is added 104 grams (0.523 eq) of 20% aqueous sodium hydroxide over approximately 10-minute period. A mixture of 37.1 grams (0.45 eq) 35% aqueous Sodium Hydrogen Sulfide and 45.0 grams (0.225 eq) 20% aqueous sodium hydroxide was prepared and added to the reactor over an approximately 10-minute period while continuing to agitate. The pH is adjusted to 4.5-5.5 with an additional 20% aqueous sodium hydroxide. Continue to agitate and maintain pH for 30 minutes. This reaction mixture is transferred to a separation flask and allowed to settle for 60 minutes. The bottom organic (product) phase is transferred to the reactor. The material is agitated, and a vacuum is applied while heating to 100 C. Cool to room temperature and filter through filter aid providing a clear product.

This method of sulfiding a high di (EHMA) stabilizer is provided as a representative method. It should be understood by those with skill in the art that other known methods of sulfiding could be used to obtain an equivalent sulfide stabilizer.

In this experiment, the sulfided high dibutyltin bis(EHMA) stabilizer, “Stabilizer B”, contained 24.5% tin, and 13.7% mercapto sulfur. It is anticipated that other resulting compositions would yield the same or similar results.

### B. PVC Compound Formulation:

PVC resin, SE-950 available from Shintech Corp., Thermolite® 31 commercially available from PMC Organometallix, Inc., lubricant package Advalube® 3315 commercially available from PMC Biogenix, Inc., impact modifier Durastrength® 535 commercially available from Arkema Inc., calcium carbonate Omyacarb® FT commercially available from Omya Corp., titanium dioxide R101 commercially available from Dupont de Nemours, Inc. and, commercially available dodecylmercaptan (DDM) and epoxidized soybean oil (ESBO) were used for PVC formulation in Example 1. Generic equivalents or alternate brands of these components could also be used.

### Testing Conditions:

The PVC compound was blended following standard additive addition order and at standard temperature known to those with skill in the art. PVC compound was evaluated in a standard window profile formulation (see Table 1) versus its non-sulfided counterpart, Thermolite® 31 for PVC applications. The color stability of each compound was evaluated using a Brabender® running operating at 190 degrees Celsius/60 rpm with samples taken in 1-minute intervals. The colors of each chip were measured in a CIE lab color space relative to a standard white tile and “b Values” are reported in Table 2. All compounds were compared on an equal tin basis.

Relative to its non-sulfided counterpart, Stabilizer B did not provide improved color as indicated by higher b values. Additionally, Stabilizer B did not improve term stability relative to Thermolite® 31. Attempts were then made to improve the performance of Stabilizer B with traditional organic extenders, in this case ESBO and DDM. These extended materials again did not provide improved performance relative to Thermolite® 31 based on b values and term stabilities in Table 2. It is expected that other traditional organic extenders known to those with skill in the art would yield similar results. Therefore, on an equal tin basis, Stabilizer B on its own or extended did not provide any improvement in term stability relative to Thermolite® 31 in PVC stability.

### C. CPVC Compound Formulation

CPVC, like its precursor PVC, is inherently unstable and requires the use of additives to allow its processing and the achievement of desirable end-use physical properties. A representative CPVC formulation as outlined in Table 3 was used for evaluations. It is expected that other CPVC formulations would yield similar results.

CPVC resin, RB1167S, commercially available from The Lubrizol Corporation; process aids Plastistrength® 551 and Plastistrength® 770 and impact modifier Clearstrength® 859 commercially available from Arkema, Inc.; wax lubricants AC-617, AC-629 and AC-316 commercially available from Honeywell International, Inc.; TiO₂ from DuPont de Nemours, Inc. and Irganox® 1010 available from BASF were using in CPVC compound formulation. It is expected that generic equivalents or alternate brands would yield the same or similar results.

The CPVC compounds were blended following standard additive addition order and temperatures. The thermal stability of each CPVC compound was evaluated using a Brabender operating at 190 degrees Celsius/50 rpm. The performance of the stabilizers was judged on the resulting term stability at the above conditions.

### Testing Conditions:

In the representative CPVC-based formulation provided in Table 3, Stabilizer B was evaluated against Thermolite® 31 (non-sulfided) at equal tin content. As detailed in Table 6, Stabilizer B only provided modest improvement in term stability which was within the experimental error of the testing equipment. Subsequently, like in the PVC work previously described, Stabilizer B was evaluated with organic extenders at 20% of stabilizer package and mixtures of organic extenders; these stabilizer systems (all at equal tin) are outlined in Table 4. These systems provided meaningful increases in term stability relative to Thermolite® 31.

This line of study was continued at higher levels of organic extenders (30% vs 20%). Table 5 outlines the stabilizing systems and Table 7 summarizes term stability results from Brabender® testing for these systems. Thermolite® 31 and compounds 12 through 22 were again run at the same tin content (0.46% tin in total formulation). Increases in term stability were observed with an up to 58% increase.

The use of sulfided tin-based stabilizers in combination with extenders has achieved term stability improvement of over 50%. This dramatic improvement could allow processors to use higher temperatures and/or higher sheer to increase productivity of CPVC processing. Additionally, reworking of CPVC with higher inherent stability will allow processors a wider processing window. Alternatively, processors could choose to add lower levels of stabilizers and co-stabilizers to run compound at lower formulation costs without reduction in product quality or output rate.

TABLE 1
PVC Compound Formulation

| | | | Extension 1 | Extension 2 |
|---|---|---|---|---|
| PVC resin, SE-950 | 100.0 | 100.0 | 100.0 | 100.0 |
| Thermolite ® 31 | 2.00 | | | |
| Stabilizer B | | 1.50 | 1.50 | 1.50 |
| ESBO | | | 0.5 | |
| DDM | | | | 0.5 |
| Advalube ® B3315 | 2.50 | 2.50 | 2.50 | 2.50 |
| Durastrenth ® 535 | 5.00 | 5.00 | 5.00 | 5.00 |
| Omyacarb ® FT | 5.00 | 5.00 | 5.00 | 5.00 |
| R101, TiO2 | 10.00 | 10.00 | 10.00 | 10.00 |
| Total | 124.5 | 124.0 | 124.5 | 124.5 |

TABLE 2
CIE b results from PVC blends

| Time, | Thermolite ® | Stabilizer | Stabilizer B | Stabilizer B |
|---|---|---|---|---|
| minutes | 31 | B | Extension 1 | Extension 2 |
| 1 | 1.52 | 2.01 | 2.11 | 2.69 |
| 2 | 3.34 | 3.84 | 4.52 | 5.99 |
| 3 | 5.68 | 5.57 | 6.31 | 7.07 |
| 4 | 6.25 | 7.38 | 8.04 | 8.40 |
| 5 | 8.68 | 21.84 | 16.88 | 15.74 |
| 6 | 18.13 | 26.21 | 27.09 | 23.63 |
| 7 | 24.24 | NA | NA | NA |

TABLE 3
CPVC COMPOUND FORMULATION

| COMPONENT | PHR |
|---|---|
| CPVC resin, RB1167S | 100.0 |
| Stabilizer | As |
| | defined |
| Plastistrength ® 551 | 0.8 |
| Clearstrength ® 859 | 7.0 |
| Plastistrenth ® 770 | 1.8 |
| AC617, wax | 1.2 |
| AC629, wax | 0.2 |
| AC316, wax | 0.2 |
| TiO₂, titanium dioxide | 1.5 |
| Irganox ® 1010, antioxidant | 0.5 |

TABLE 4
Summary of Stabilizer B Blends, Set 1, at 81% with Extenders

| | Control | 1 | 2 | 3 | 4 | 5 | 6 | 7 | 8 | 9 | 10 | 11 |
|---|---|---|---|---|---|---|---|---|---|---|---|---|
| Thermolite ® 31 | 100 | | | | | | | | | | | |
| Stabilizer B | | 100 | 81 | 81 | 81 | 81 | 81 | 81 | 81 | 81 | 81 | 81 |
| DDM | | | 19 | | | | 9.5 | 9.5 | 9.5 | | | |
| Paraffin | | | | 19 | | | 9.5 | | | 9.5 | 9.5 | |
| Mercapto Fatty | | | | | 19 | | | 9.5 | | 9.5 | | 9.5 |
| Acid | | | | | | | | | | | | |
| ESBO | | | | | | 19 | | | 9.5 | | 9.5 | 9.5 |

TABLE 5
Summary of Stabilizer B Blends, Set 2, at 70% with Extender

| | Control | 12 | 13 | 14 | 15 | 16 | 17 | 18 | 19 | 20 | 21 | 22 |
|---|---|---|---|---|---|---|---|---|---|---|---|---|
| Thermolite ® 31 | 100 | | | | | | | | | | | |
| Stabilizer B | | 100 | 70 | 70 | 70 | 70 | 70 | 70 | 70 | 70 | 70 | 70 |
| DDM | | | 10 | 15 | 20 | 10 | 15 | 20 | | | | |
| Paraffin | | | 20 | 15 | 10 | | | | 10 | 15 | 20 | 30 |
| Mercapto Fatty | | | | | | | | | | | | |
| Acid | | | | | | | | | | | | |
| ESBO | | | | | | 20 | 15 | 10 | 20 | 15 | 10 | |

TABLE 6
Brabender ® Term Stability Results, Set 1

| | | Term | Relative |
|---|---|---|---|
| | Loading | Stability | Improvement to |
| Sample | Level | (seconds) | Thermolite ® 31 |
| Thermolite ® 31 | 3.0 | 1156 | NA |
| 1, Stabilizer B | 2.25 | 1186 | 103% |
| 2 | 2.8 | 1534 | 133% |
| 3 | 2.8 | 1378 | 119% |
| 4 | 2.8 | 1310 | 113% |
| 5 | 2.8 | 1438 | 124% |
| 6 | 2.8 | 1720 | 149% |
| 7 | 2.8 | 1436 | 124% |
| 8 | 2.8 | 1518 | 131% |
| 9 | 2.8 | 1440 | 125% |
| 10 | 2.8 | 1528 | 132% |
| 11 | 2.8 | 1294 | 112% |

TABLE 7
Brabender Term Stability Results, Set 2

| | Loading | Term | % Relative |
|---|---|---|---|
| | level | Stability | Improvement to |
| Sample | phr | (seconds) | Thermolite ® 31 |
| Thermolite ® 31 | 3.0 | 1134 | NA |
| 12, Stabilizer B | 2.25 | 1304 | 115 |
| 13 | 3.24 | 1524 | 134 |
| 14 | 3.24 | 1632 | 144 |
| 15 | 3.24 | 1544 | 136 |
| 16 | 3.24 | 1582 | 140 |
| 17 | 3.24 | 1490 | 131 |
| 18 | 3.24 | 1642 | 145 |
| 19 | 3.24 | 1404 | 124 |
| 20 | 3.24 | 1510 | 133 |
| 21 | 3.24 | 1534 | 135 |
| 22 | 3.24 | 1790 | 158 |

Further experimentation is expected to yield similar results.

### Proposed Experiment 2

A. Prepare a sulfided version of high dimethyl tin bis(EHMA) stabilizer, for example TM181FS, commercially available from PMC Organometallix, Inc., and extend using traditional organic extenders as described in the foregoing example, to create “Stabilizer C”.
B. Compare performance of TM181FS or equivalent with Stabilizer C in PVC stability using Brabender® and color scale as described in the foregoing example.
C. Compare performance of TM181FS or equivalent with Stabilizer C in CPVC stability using Brabender® and color scale as described in the foregoing example. Additional testing may be done on other commercial CPVC compositions not described above.

It is expected that, as has been described in the foregoing example, Stabilizer C will perform better than its non-sulfided high dimethyl tin bis(EHMA) counterpart in CPVC stability.

### Proposed Experiment 3

A. Prepare a sulfided version of high di-octyl tin bis(EHMA) stabilizer, for example T890F, commercially available from PMC Organometallix, Inc., and extend using traditional organic extenders as described in the foregoing example, to create “Stabilizer D”.
B. Compare performance of T890F or equivalent with Stabilizer D in PVC stability using Brabender® and color scale as described in the foregoing example.
C. Compare performance of T890F or equivalent with Stabilizer D in CPVC stability using Brabender® and color scale as described in the foregoing example. Additional testing may be done on other commercial CPVC compositions not described above.

It is expected that, as has been described in the foregoing example, Stabilizer D will perform better than its non-sulfided high di-octyl tin bis(EHMA) counterpart in CPVC stability.

The present invention includes a stabilizer for post-halogenated halogen-containing polymers. In preferred embodiments, the stabilizer includes at least (a) dibutyltin bis(ethylhexylmercaptoacetate) (dibutyltin bis(EHMA)), the dibutyltin bis(EHMA) having ligands, (b) wherein some quantity of the ligands in the dibutyltin bis(EHMA) are synthetically replaced with a sulfide, and (c) an organic stabilizer extender.

In some embodiments, the stabilizer includes at least (a) dimethyltin bis(ethylhexylmercaptoacetate) (dimethyltin bis(EHMA)), the dimethyltin bis(EHMA) having ligands, (b) wherein some quantity of the ligands in the dimethyltin bis(EHMA) are synthetically replaced with a sulfide, and (c) an organic stabilizer extender.

In some embodiments, the stabilizer includes at least (a) Di-octyltin bis(ethylhexylmercaptoacetate) (di-octyltin bis(EHMA)), the di-octyltin bis(EHMA) having ligands, (b) wherein some quantity of the ligands in the di-octyltin bis(EHMA) are synthetically replaced with a sulfide, and (c) an organic stabilizer extender.

In preferred embodiments, the organic stabilizer extender in the stabilizers described above is (i) epoxidized soybean oil (ESBO) or (ii) dodecylmercaptan (DDM).

The present invention also includes a method of using the stabilizers of the invention in production of post-halogenated halogen-containing polymers. In preferred embodiments, the method is used for stabilizing post-halogenated halogen-containing polymers, more preferable, the polymer is chlorinated poly vinyl chloride (CPVC).

The present invention also includes an article comprised of a post-halogenated halogen-containing polymer that has been preparing using the stabilizers of the present invention. In preferred embodiments, the article includes CPVC as the post-halogenated halogen-containing polymer.

The present invention also includes a sulfided stabilizer composition for the stabilization of post halogenated polymers of the formula R_{4-2x-y}Sn(S)ₓL_{y}, where is an alkyl group and L is a ligand. In preferred embodiments, x is most preferably from 0.05 to 0.75 and y is most preferably from 1.5 to 2.8. However, broader ranges of x and y values may also be suitable, such as x being from 0.01-1.5 and y being from 0.5-4.0. In preferred embodiments of this sulfided stabilizer composition, R can be linear or branched alkyls, more preferably, the linear or branched alkyls are from C1 to C10. In preferred embodiments of this sulfided stabilizer composition, L can be drawn from traditional ligands used in tin-based thermal stabilizers for post-halogenated polymers and preferably include, but are not limited to, mercapto esters, mercaptides, thio alcohols, and carboxylates.

The stabilizers of the presented invention are preferably used as a stabilizer system to provide thermal protection for post-halogenated polymers and can be used alone or in combination with other traditional thermal stabilizers. In some embodiments, the stabilizing systems are used in combination with traditional organic or inorganic co-stabilizers including, but not limited to, mercaptans, fatty acid esters, epoxidized fatty acids and hydrocarbon oils and waxes. Preferably, in these stabilizing systems the ratio of sulfided tin-based component to organic extender(s) is from 1:1 to 5:1.

The above proposed experiments and examples are based on traditional CPVC stabilizers. Further experimentation is expected to show that the same sulfiding and extending process described will enhance performance of other PVC or halogen-containing polymer stabilizers for use with CPVC or other post-halogenated, halogen-containing polymers. For example, a bridged stabilizer could be sulfided and, possibly extended to enhance CPVC stability. Other stabilizers could be sulfided and, possibly extended to enhance CPVC stability.

The foregoing formulations are presented only as examples and are not intended to limit the scope of the subject invention. One with skill in the art would understand that equivalents to the brands used in the foregoing experiments and examples could be used to achieve the same or similar results. Additionally, the ongoing experimentation described herein may provide more alternatives to these examples other than those known to one with skill in the art.

1. A stabilizer for post-halogenated halogen-containing polymers, the stabilizer comprising
a. dialkyltin bis(ethylhexylmercaptoacetate) (dialkyltin bis(EHMA)), the dialkyltin bis(EHMA) having ligands,
b. wherein some quantity of the ligands in the dialkyltin bis(EHMA) are synthetically replaced with a sulfide, and
c. an organic stabilizer extender.

2. The stabilizer for post-halogenated halogen-containing polymers of claim 1, wherein the dialkyltin is dibutyltin.

3. The stabilizer for post-halogenated halogen-containing polymers of claim 1, wherein the dialkyltin is dimethyltin.

4. The stabilizer of claim 1 wherein the extender is chosen from the group consisting of epoxidized soybean oil (ESBO) or dodecylmercaptan (DDM).

5. A method of using the stabilizer of claim 1 in production of post-halogenated halogen-containing polymers, the method comprising steps of: (a) blending post-halogenated polymer resin with one or more process aids, one or more impact modifiers, one or more ax lubricants, and TiO₂; and, (b) following standard additive addition order and temperature.

6. The method of claim 5 wherein the post-halogenated halogen-containing polymer is chlorinated poly vinyl chloride (CPVC).

7. An article comprised of a post-halogenated halogen-containing polymer that has been preparing using the stabilizer of claim 1.

8. The article of claim 7 wherein the post-halogenated halogen-containing polymer is CPVC.

9. A sulfided stabilizer composition for the stabilization of post halogenated polymers of the formula R_{4-2x-y}Sn(S)ₓL_{y}, where x is from 0.05 to 0.75 and y is from 1.5 to 2.8.

10. The sulfided stabilizer composition of claim 9, wherein R is linear or branched alkyls from C1 to C10.

11. The sulfided stabilizer composition of claim 9, wherein L is drawn from traditional ligands used in tin-based thermal stabilizers for post-halogenated polymers and include, but not limited to, mercapto esters, mercaptides, thio alcohols, and carboxylates.

12. The stabilizer compositions described in claim 9 used as a stabilizer system to provide thermal protection for post halogenated polymers used alone or in combination with other traditional thermal stabilizers.

13. The stabilizing systems described in claim 12 used in combination with traditional organic or inorganic co-stabilizers including, but not limited to, mercaptans, fatty acid esters, epoxidized fatty acids and hydrocarbon oils and waxes.

14. The stabilizing systems described in claim 13 in which the ratio of sulfided tin-based component to organic extender(s) is from 1:1 to 5:1.

15. (canceled)

16. The stabilizer of claim 2 wherein the extender is chosen from the group consisting of epoxidized soybean oil (ESBO) or dodecylmercaptan (DDM).

17. The stabilizer of claim 3 wherein the extender is chosen from the group consisting of epoxidized soybean oil (ESBO) or dodecylmercaptan (DDM).

18. A method of using the stabilizer of claim 2 in production of post-halogenated halogen-containing polymers, the method comprising steps of:
(a) blending post-halogenated polymer resin with one or more process aids, one or more impact modifiers, one or more ax lubricants, and TiO₂; and, (b) following standard additive addition order and temperature.

19. A method of using the stabilizer of claim 3 in production of post-halogenated halogen-containing polymers, the method comprising steps of:
(a) blending post-halogenated polymer resin with one or more process aids, one or more impact modifiers, one or more ax lubricants, and TiO₂; and, (b) following standard additive addition order and temperature.

20. The stabilizer for post-halogenated halogen-containing polymers of claim 1, wherein the dialkyltin is dioctyltin.
